(19) United States
(12) Patent Application Publication
(10) Pub. No.: US 2015/0067192 A1
(43) Pub. Date: Mar. 5, 2015

(54) SYSTEM AND METHOD FOR ADJUSTING SAS ADDRESSES OF SAS EXPANDERS

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/163,640

(22) Filed: Jan. 24, 2014

(30) Foreign Application Priority Data
Aug. 27, 2013 (TW) 102130591

(51) Int. Cl. G06F 3/06

(52) U.S. Cl. CPC G06F 3/0638; G06F 3/0604; G06F 3/0683
USPC 710/4

(57) ABSTRACT

In a method for adjusting SAS addresses of SAS expanders in an SAS storage system, an initial SAS address of a specified SAS expander is read when the specified SAS expander is first connected to a processor of the SAS storage system. SAS addresses of other SAS expanders that are already connected to the processor are obtained. The initial SAS address of the specified SAS expander is compared with the obtained SAS addresses. When the initial SAS address is identical to one of the obtained SAS addresses, the initial SAS address is adjusted according to a predefined address number to generate an updated SAS address of the specified SAS expander. The initial SAS address of the specified SAS expander is reset according to the updated SAS address.

### FIELD

Embodiments of the present disclosure relate to Serial Attached Small Computer System Interface (SAS) expanders, and particularly to a system and a method for adjusting SAS addresses of SAS expanders.

### BACKGROUND

An SAS storage system includes a plurality of SAS expanders. Each of the SAS expanders has a unique SAS address. If there are two or more SAS expanders that have the same SAS address, the storage system cannot find devices and hardware connected to the corresponding SAS expanders, and errors in data-reading or writing may occur. Thus, one or more of the SAS expanders having the same SAS address needs to be removed and have a new SAS address assigned, or additional hardware needs to be acquired to assign new SAS addresses to the SAS expanders.

### BRIEF DESCRIPTION OF THE DRAWINGS

Implementations of the present disclosure will now should be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views

FIG. 1 is a block diagram of one embodiment of a Serial Attached Small Computer System Interface (SAS) storage system including an adjustment system.

FIG. 2 is a block diagram of one embodiment of function modules of the adjustment system included in the SAS storage system of FIG. 1.

FIG. 3 is a flowchart of one embodiment of a method for adjusting SAS addresses of SAS expanders in the SAS storage system of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

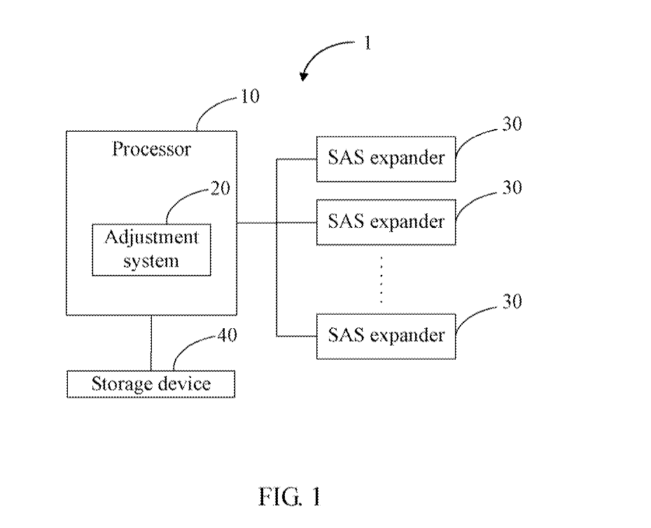

FIG. 1 is a block diagram of one embodiment of a serial attached small computer system interface (SAS) storage system 1 including an adjustment system 20. The adjustment system 20 is executed by a hardware processor 10 of the SAS storage system 1. The processor 10 is electrically connected to a plurality of SAS expanders 30. Each of the SAS expanders 30 can be connected to one or more hardware devices (not shown in FIG. 1), such as a hard disk drive (HDD), for example. Each of the SAS expanders 30 has an initial SAS address. The SAS address is an address value represented by a hex number and used to identify a communication channel of the respective SAS expander 30.

In one embodiment, each of the SAS expanders 30 includes a flash memory (not shown in FIG. 1) for embedding a firmware of the SAS expander 30. The firmware is embedded in the SAS expander 30 and makes functions of the SAS expander 30 work normally, and can be updated or upgraded. The firmware can be used to accommodate configuration parameters of the SAS expander 30. The configuration parameters can be, but are not limited to, configuration data of a physical layer (PHY) of the SAS expander 30, address data of the SAS expander 30, and connection data of the PHY of the SAS expander 30.

In one embodiment, if the initial SAS address conflicts with one of the other SAS addresses of the other SAS expanders 30, the adjustment system 20 resets the initial SAS address of a specified SAS expander 30 by adjusting the initial SAS address by a predefined address number. The adjustment system 20 may include computerized instructions in the form of one or more programs that are stored in a storage device 40 of the SAS storage system 1 and executed by the processor 10.

In one embodiment, the storage device 40 may be an internal storage device, such as a random access memory (RAM) for temporary storage of information, and/or a read-only memory (ROM) for permanent storage of information. The storage device 40 may also be an external storage device, such as an external hard disk, a storage card, network attached storage (NAS), a web database, or a data storage medium. The processor 10 can be a central processing unit (CPU) or data processor that performs various functions of the SAS storage system 1.

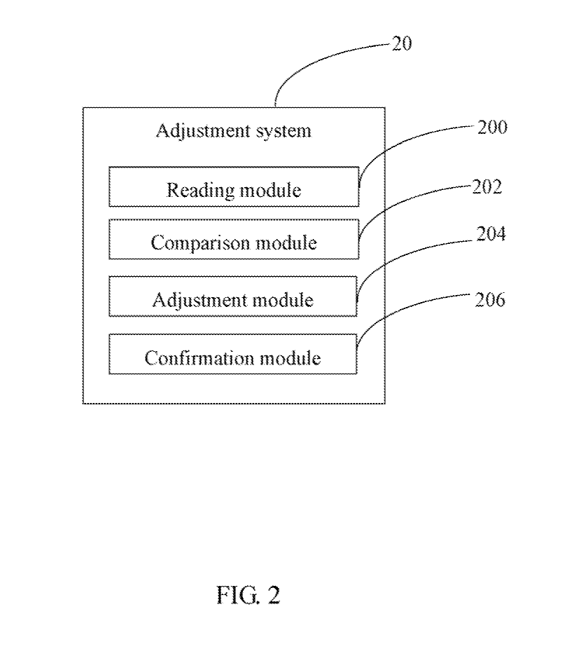

FIG. 2 is a block diagram illustrating function modules of the adjustment system 20 of FIG. 1. In the embodiment, the adjustment system 20 includes a reading module 200, a comparison module 202, an adjustment module 204, and a confirmation module 206. The modules 200, 202, 204, and 206 may comprise computerized instructions in the form of one or more computer-readable programs that are executed by the processor 10. A description of each module is given in the following paragraphs.

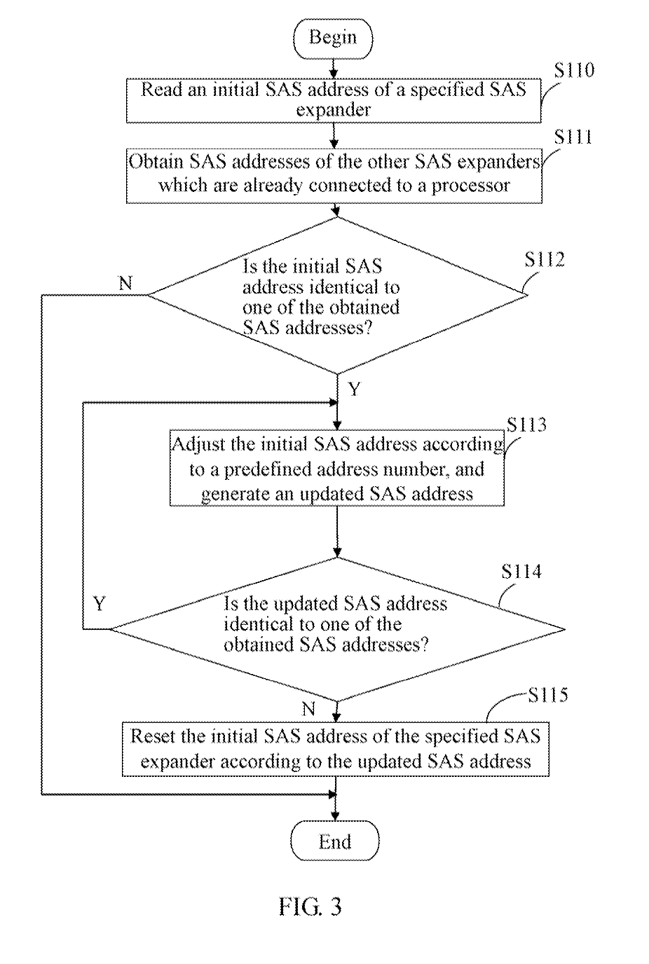

FIG. 3 is a flowchart of one embodiment of a method for adjusting SAS addresses of SAS expanders 30 in the SAS storage system 1. Depending on the embodiment, additional steps may be added, others removed, and the ordering of the steps may be changed.

In step S110, the reading module 200 reads an initial SAS address of a specified SAS expander 30 when the specified SAS expander 30 is first connected to the processor 10.

In step S111, the comparison module 202 obtains SAS addresses of the other SAS expanders 30 that are already connected to the processor 10. If there are no other SAS expanders 30 that are already connected to the processor 10, the procedure ends.

In step S112, the comparison module 202 compares the initial SAS address with the obtained SAS addresses, and determines whether or not the initial SAS address is substantially identical to one of the obtained SAS addresses. If the initial SAS address is not substantially identical to any of the obtained addresses, then the initial SAS address of the specified SAS expander is not adjusted, and the procedure ends. If the initial SAS address is identical to one of the obtained SAS addresses, then step S113 is implemented.

In step S113, the adjustment module 204 adjusts the initial SAS address by a predefined address number and generates an updated SAS address of the specified SAS expander 30. In one embodiment, the adjustment module 204 adjusts the initial SAS address by adding the predefined address number to the initial SAS address. For example, if the predefined address number is defined as “40,” and the initial SAS address is 0x500605330000013F, the adjustment module 204 obtains an updated SAS address 0x500605330000017F by adding the predefined address number “40” to the original SAS address 0x500605330000013F.

In step S114, the comparison module 202 compares the updated SAS address with the obtained SAS addresses, and determines whether or not the updated SAS address is substantially identical to one of the obtained addresses. If the updated SAS address is substantially identical to one of the obtained SAS addresses, the procedure returns to step S113, and the adjustment module 204 adjusts the updated SAS address until the updated SAS address is not identical to any of the obtained SAS addresses. If the initial SAS address is not substantially identical to any of the obtained addresses, step S115 is implemented.

In step S115, the confirmation module 206 resets the initial SAS address of the specified SAS expander 30 according to the updated SAS address.

All of the processes described above may be embodied in, and fully automated via, functional code modules executed by one or more general purpose processors such as the processor 30. The code modules may be stored in any type of non-transitory readable medium or other storage device such as the storage system 30. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A method for adjusting serial attached small computer system interface (SAS) addresses of SAS expanders in an SAS storage system, the method comprising:
reading an initial SAS address of a specified SAS expander when the specified SAS expander is first connected to a processor of the SAS storage system;
obtaining SAS addresses of other SAS expanders which are already connected to the processor, and comparing the initial SAS address with the obtained SAS addresses;
adjusting the initial SAS address according to a predefined address number and generating an updated SAS address of the specified SAS expander, when the initial SAS address is identical to one of the obtained addresses; and
resetting the initial SAS address of the specified SAS expander according to the updated SAS address.

2. The method according to claim 1, further comprising:
adjusting the updated SAS address according to the predefined address number, the updated SAS address is substantially identical to one of the obtained addresses.

3. The method according to claim 1, wherein the initial SAS address of the specified SAS expander is not adjusted when the initial SAS address is not identical to any of the obtained addresses.

4. The method according to claim 1, wherein the initial SAS address is adjusted by adding the predefined address number into the initial SAS address.

5. A serial attached small computer system interface (SAS) storage system comprising a plurality of SAS expanders, the storage system comprising:
at least one processor; and
a storage device storing one or more programs, when executed by the at least one processor, cause the at least one processor to perform operations of:
reading an initial SAS address of a specified SAS expander when the specified SAS expander is first connected to a processor of the SAS storage system;
obtaining SAS addresses of other SAS expanders which are already connected to the processor, and comparing the initial SAS address with the obtained SAS addresses;
adjusting the initial SAS address according to a predefined address number and generating an updated SAS address of the specified SAS expander, when the initial SAS address is identical to one of the obtained addresses; and
resetting the initial SAS address of the specified SAS expander according to the updated SAS address.

6. The SAS storage system according to claim 5, further comprising:
adjusting the updated SAS address according to the predefined address number, when the updated SAS address is identical to one of the obtained addresses.

7. The SAS storage system according to claim 5, wherein the initial SAS address of the specified SAS expander is not adjusted when the initial SAS address is not identical to any of the obtained SAS addresses.

8. The SAS storage system according to claim 5, wherein the initial SAS address is adjusted by adding the predefined address number into the initial SAS address.

9. A non-transitory storage medium having stored thereon instructions that, when executed by at least one processor of a serial attached small computer system interface (SAS) storage system, cause the processor to perform a method for adjusting SAS addresses of SAS expanders in the SAS storage system, the method comprising:
reading an initial SAS address of a specified SAS expander when the specified SAS expander is first connected to a processor of the SAS storage system;
obtaining SAS addresses of other SAS expanders which are already connected to the processor, and comparing the initial SAS address with the obtained SAS addresses;
adjusting the initial SAS address according to a predefined address number and generating an updated SAS address of the specified SAS expander, when the initial SAS address is identical to one of the obtained addresses; and
resetting the initial SAS address of the specified SAS expander according to the updated SAS address.

10. The storage medium according to claim 9, further comprising:
adjusting the updated SAS address according to the predefined address number, when the updated SAS address is identical to one of the obtained SAS addresses.

11. The storage medium according to claim 9, wherein the initial SAS address of the specified SAS expander is not adjusted when the initial SAS address is not identical to any of the obtained SAS addresses.

12. The storage medium according to claim 9, wherein the initial SAS address is adjusted by adding the predefined address number into the initial SAS address.
